(19) United States
(12) Patent Application Publication
(10) Pub. No.: US 2015/0176999 A1
(43) Pub. Date: Jun. 25, 2015

(54) NAVIGATIONAL AID SYSTEM AND METHOD IMPLEMENTED IN SUCH A SYSTEM

(71) Applicant: IXBLUE, Marly Le Roi (FR)

(72) Inventor: Stephane BELOT, D'Huison Longueville (FR)

(21) Appl. No.: 14/577,366

(22) Filed: Dec. 19, 2014

(30) Foreign Application Priority Data
Dec. 20, 2013 (FR) 1363314

(51) Int. Cl. G01C 21/00

(52) U.S. Cl. CPC G01C 21/00

(57) ABSTRACT

A navigational aid system is designed to switch between an operating mode certified according to a standard and a non-certified operating mode. It is based on a modular architecture and implemented by the execution of compliant modules (MOD₁, MOD₂) having an attribute of compliance and of modules (MOD₃, MOD₄) with no attribute of compliance. An indicator (IND) is provided, which is representative of the current operating mode; the compliant modules (MOD₁, MOD₂) are designed to call a function (FN₁, FN₂, FN₃, SRV) of another module, only when the indicator (IND) is representative of the non-certified operating mode or when the other module has an attribute of compliance.

### TECHNICAL FIELD TO WHICH RELATES THE INVENTION

The present invention generally relates to the navigational aid tools, in particular for the maritime navigation.

It more particularly relates to a navigational aid system designed to switch between an operating mode certified according to a standard and a non-certified operating mode. The present invention also relates to a method implemented in such a system.

### TECHNOLOGICAL BACKGROUND

Certain maritime navigational aid systems are designed in conformity with manufacturing standards defined by the SOLAS (“Safety of Life at Sea”) convention of the International Maritime Organization and identified under the name ECDIS (for “Electronic Chart Display and Information System”).

These specific manufacturing standards may however not respond to certain needs, in particular when it is desired to add to the navigation aid system functionalities that are useful for certain applications, for example sea fishing.

Moreover, modular architecture systems are known, in which the operation of the system is based on the cooperation of different modules.

When the use of such a system is subjected to certification, it is conventionally required to proceed to the certification of all the modules that cooperate with each other in order to guarantee the certified operation of the system.

### OBJECT OF THE INVENTION

Within this context, the present invention proposes a navigational aid system designed to switch between an operating mode certified according to a standard and a non-certified operating mode (with respect to this standard), characterized in that it is based on a modular architecture, in that it is implemented by the execution of modules compliant with the standard, having an attribute of compliance, and of modules with no attribute of compliance, in that it comprises an indicator representative of the current operating mode, and in that the compliant modules are designed to call a function of another module only when the indicator is representative of the non-certified operating mode or when the other module has an attribute of compliance.

Hence, when the certified operating mode is active, only calls from compliant module to compliant module are implemented, and the modules with no attribute of compliance (for which there is no design constraint) are hence not prompted. The modular architecture of the system, which is interesting due to the design flexibility provided thereby, is hence not harmful to the security of the certified operating mode.

The switching from an operating mode to the other can further be operated dynamically, by simple modification of the above-mentioned indicator (for example in response to a command from the user) and without stopping the system, due to the fact that the different modules have no need to be modified to take into account the change of operating mode.

In particular, it may be provided that at least one compliant module is designed to look at the indicator and to adapt its operation as a function of the operating mode indicated by the indicator. As a variant, it may be provided that the system (for example by means of an operating mode management element) is designed to transmit, to at least one compliant module, a notification specifying that the indicator has a determined value; the compliant module may then be designed to adapt its operation as a function of the operating mode indicated by said determined value.

According to a possibility of implementation, at least one compliant module may be designed to determine if another module has an attribute of compliance by interrogating said other module. As a variant, it could be provided that the compliant module looks at a table listing the attributes of compliance of the different modules.

A graphic interface management element is for example designed to call a function of tracing on a screen of the system, implemented by a graphic module, only when the indicator is representative of the non-certified operating mode or when the graphic module has an attribute of compliance. This graphic interface management element may be a primary module or another module, which will be called for example by the primary module, or, in an architecture of the components/container type, the container (also referred to as core or docking structure).

It may also be provided, as explained hereinafter, that an operating mode management element is designed to interrogate a given module about the availability of a command of the given module when the indicator is representative of the non-certified operating mode or when the given module has an attribute of compliance, and to deactivate said command in the other cases. As for the graphic interface management element, the operating mode management element may be the above-mentioned primary module or another module, which will be called for example by the primary module, or, in an architecture of the components/container type, the container.

According to a conceivable embodiment, the indicator may take a value representative of an alternative certified operating mode, in which for example only the cartography and the mobiles (herein the boats) are displayed on the screen. At least one compliant module may then be designed to adapt its operation to the alternative certified mode when the indicator has the value representative of the alternative certified operating mode. This compliant module may for example look at the indicator for that purpose or receive a notification signalling the (new) value of the indicator, for example from the operating mode management element.

The invention also proposes a method implemented in a navigational aid system designed to switch between an operating mode certified according to a standard and a non-certified operating mode, characterized in that the system is based on a modular architecture, in that the method is implemented by the execution of modules compliant with the standard, having an attribute of compliance, and of modules with no attribute of compliance, and in that the method includes the following steps:
updating of an indicator representative of the current operating mode,
calling of a function of another module only when the indicator is representative of the non-certified operating mode or when the other module has an attribute of compliance.

In an embodiment, the method further comprises the following steps:
look-up of the indicator by a compliant module;
adaptation, by the compliant module, of the operation thereof as a function of the operating mode indicated by the indicator.

The method can also comprise a step of interrogation of another module by a compliant module to determine if the other module has an attribute of compliance.

According to a possibility of implementation, the method comprises a step of calling, by a graphic interface management element, of a function of tracing on a screen of the system, implemented by a graphic module, only when the indicator is representative of the non-certified operating mode or when the graphic module has an attribute of compliance.

It may further be provided a step of interrogation, by an operating mode management element, of a given module about the availability of a command of the given module when the indicator is representative of the non-certified operating mode or when the given module has an attribute of compliance, or of deactivation of said command in the other cases.

As indicated above, the indicator may in certain embodiments further take a value representative of an alternative certified operating mode. It may then be provided a step of adaptation, by at least one compliant module, of the operation thereof to the alternative certified mode when the indicator has the value representative of the alternative certified operating mode.

### BRIEF DESCRIPTION OF THE DRAWINGS

The following description, taken in combination with the appended drawings, given by way of non-limitative examples, will permit to understand in what consists the invention and how it can be implemented.

In the appended drawings:

FIG. 1 schematically shows the main elements of an example of navigational system compliant with the teachings of the invention;

FIG. 2 shows the operation of the navigational aid system of FIG. 1, in a non-certified operating mode;

FIG. 3 shows the operation of the navigational aid system of FIG. 1, in a certified operating mode;

FIG. 4 shows a method of tracing a graphic representation within the framework of the navigational system of FIG. 1;

FIG. 5 shows the management of a tool bar within the framework of the navigational system of FIG. 1.

### DETAILED DESCRIPTION OF THE INVENTION

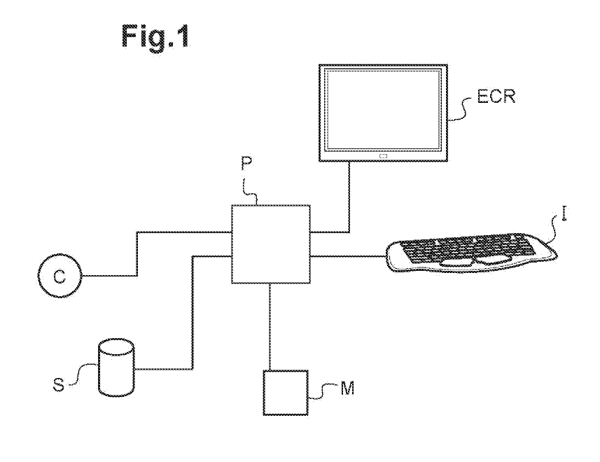

FIG. 1 schematically shows an example of maritime navigational system: it is herein a microprocessor-based system, which comprises in particular a processor (in this case a microprocessor) P, a memory M associated with the processor P, a user interface I (typically a keyboard or a mouse), a screen ECR and memorization means S, for example a hard disk.

The system also comprises a sensor C for measuring a parameter useful for the navigation. The present description mentions only one sensor C, but the described navigational aid system could naturally include other sensors.

The memory M stores in particular computer programs, implemented as modules, whose execution by the processor P allows the implementation of a navigational aid method, which comprises in particular steps of displaying information (typically graphic representations or graphic objects, as described hereinafter) on the screen ECR, steps of acquiring information from the sensor C and steps of receiving instructions from the user through the user interface I.

It could be provided as a variant that each module mentioned hereinafter is executed (i.e. implemented) by means of a dedicated integrated circuit, for example a specific application integrated circuit (or ASIC).

The memory also stores data and parameters useful for the implementation of the navigational aid method.

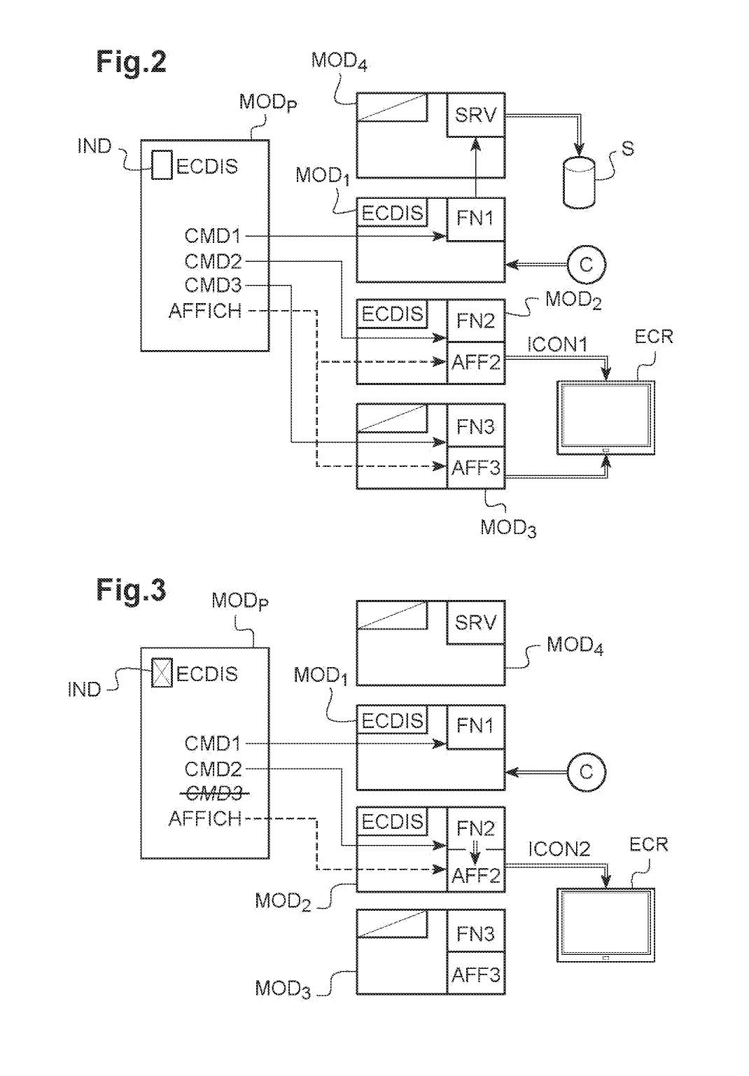

FIG. 2 shows various modules MOD_{P}, MOD₁, MOD₂, MOD₃, MOD₄ involved in the implementation of the maritime navigational aid system. These modules comprise a primary module MOD_{P}, whose execution is launched at the initialization of the system, modules MOD₁, MOD₂ compliant with a standard, herein the ECDIS standard, and hence having an attribute of compliance, and modules MOD₃, MOD₄ with no attribute of compliance, designed without taking into consideration the design rules dictated by the concerned standard.

The compliant modules are designed so that their implementation within the navigational aid system is compliant with the concerned standard, herein the ECDIS standard, and that the navigational aid system can hence claim the certification according to the concerned standard. In the present description the ECDIS standard is aimed at as an example of certification standard; other types of certification are however conceivable within the framework of the present invention, for example according to the ARPA (“Automatic Radar Plotting Aid”) standard.

Each module is for example designed to receive a request of interrogation about the presence of an attribute of compliance and to reply positively in the case where the concerned module has effectively an attribute of compliance, as explained hereinafter.

The primary module MOD_{P} is also compliant with the standard but has no attribute of compliance (because it is not itself called by another module and it is hence not necessary to determine if this module is compliant with the ECDIS standard before calling it).

The primary module MOD_{P} manages an indicator IND of the operating mode. This indicator is for example memorized in the memory M associated with the processor P and can take a value representative of the operation in a non-certified mode (herein a non-ECDIS mode) or a value representative of the operation in a certified mode (herein an ECDIS mode).

This indicator IND can be modified only by the module (or more generally the element) in charge of the management of the certified operating mode, herein the primary module MOD_{P}; the indicator is for example modified due to a choice of the user, typically by interactive selection (through the user interface I) of the desired operating mode in a menu displayed on the screen ECR.

The indicator IND may on the other hand be looked at by the other modules MOD₁, MOD₂, MOD₃, MOD₄, in particular by the compliant modules MOD₁, MOD₂ so as to determine the active operating mode and to possibly adapt their operation to the active mode, as explained hereinafter.

In the present description, the certification with respect to a particular standard, herein the ECDIS standard, is considered. Hence, the non-certified operating mode does not aim at respecting the concerned standard; this operating mode could however be compliant with another certification standard without departing from the framework of the invention.

In the operating state shown in FIG. 2, the non-certified mode is active and the indicator IND is hence representative of the non-certified operating mode (herein non-ECDIS).

The primary module MOD_{P} can control the execution of a plurality of commands CMD₁, CMD₂, CMD₃, by calling on a function associated with the concerned command within a module that comprises this function.

For example, the primary module MOD_{P} is adapted to control the execution of the command CMD₁ by calling on a function FN₁ of the module MOD₁; likewise, the primary module MOD_{P} can control the execution of a command CMD₂ by calling on a function FN₂ of the module MOD₂; finally, the primary module MOD_{P} can control the execution of a command CMD₃ by calling on a function FN₃ of the module MOD₃.

The execution of one of the above-mentioned commands CMD₁, CMD₂, CMD₃ is for example performed upon a command from the user, by interactive selection of the command in a menu displayed on the screen ECR.

In the example described herein, the primary module MOD_{P} also manages the display of the screen ECR, in particular the display of the above-mentioned menus and the display of the graphic representations or objects (for example, icons) linked to the operation of the other modules.

For that purpose, the primary module MOD_{P} calls in particular on tracing functions AFF₂, AFF₃ (implemented by associated modules MOD₂, MOD₃, respectively), which cause the tracing of graphic representations on the screen ECR, when they receive a call for that purpose from the primary module MOD_{P}, as explained in more detail hereinafter.

The module MOD₁ is designed to receive measurement information from the sensor C and, during the operation in the non-certified mode, to call on a function SRV of the module

MOD₄, for example so that the module MOD₄ processes the data measured by the sensor C and memorizes the data processed in the memorization means S.

The module MOD₂ contains, as already indicated, a function FN₂, which corresponds to a command CMD₂ that can be triggered by the user, and a function AFF₂ of tracing a plurality of icons ICON₁ not compliant with the certified operating mode (herein not compliant with the ECDIS standards).

The module MOD₃ contains a function FN₃ that can be triggered by the user and a tracing function AFF₃ that generates on the screen ECR a graphic representation associated with the operation of the command CMD₃.

FIG. 3 schematically shows the operation of the system after switching to the certified operating mode (herein the ECDIS mode).

As indicated above, the switching from the non-certified mode to the certified mode is made for example when the user selects the certified mode from a menu displayed on the screen ECR, which results in modifying the indicator IND of the current operating mode.

At the time of switching (and possibly at other instants of operation of the system), the primary module MOD_{P} transmits a notification to all the modules MOD₁, MOD₂, MOD₃, SRV (or possibly to only the compliant modules MOD₁, MOD₂). This notification contains for example the indicator IND so as to specify the new current operating mode.

The compliant modules MOD₁, MOD₂ then adapt their operation to the new operating mode (herein the ECDIS mode), as explained hereinafter. Besides, the primary module MOD_{P} inhibits the operation of the modules with no attribute of compliance MOD₃, SRV, for example by transmitting a request of termination (i.e. of end of execution) to each of these modules MOD₃, SRV.

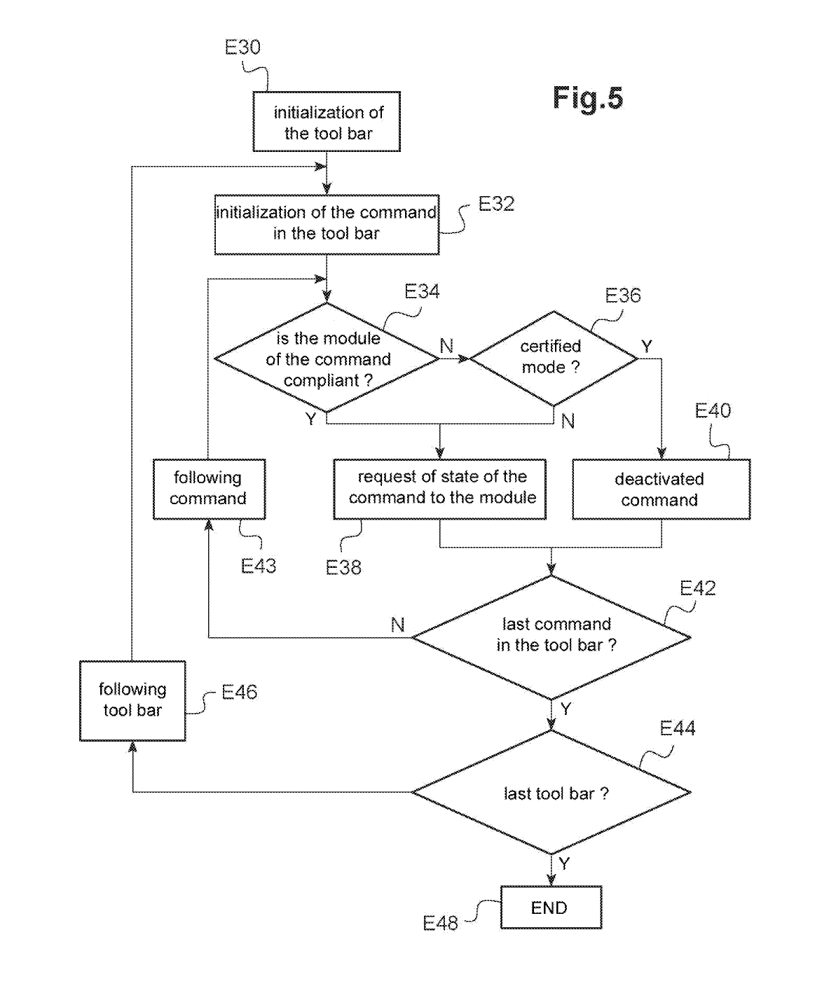

When the certified mode is activated, as shown in FIG. 3, the list of the commands to which the user can access is further updated, for example due to the periodic implementation of the method described hereinafter with reference to FIG. 5.

Precisely, after having detected the interactive selection of the certified mode by the user, the primary module MOD_{P} deactivates in particular the commands using a function of a module with no attribute of compliance, as described with reference to FIG. 5, and displays an updated menu, which comprises the updated list of the available commands, as well as, for example, the non-available commands with a different graphic representation, for example in grey to indicate to the user that these commands are inactive.

The user can then trigger only commands that are implemented by the execution of a function of a module compliant with the concerned standard (herein the ECDIS standard), which guarantees the certified operation of the device, despite the presence of the modules with no attributes of compliance MOD₃, MOD₄.

Indeed, the compliant modules have to answer to specific requests, which may be transmitted by the primary module MOD_{P}, such as a request for changing the colour mode (day mode, night mode, twilight mode) of the display or a danger verification demand.

Likewise, the compliant module MOD₁ is designed to test, during its execution, the value of the indicator IND of the current operating mode and to operate in conformity with the required standard (herein the ECDIS standard) when the indicator IND is representative of a certified-mode operation.

For example, the module MOD₁ no longer calls on the module MOD₄ (which has no attribute of compliance) as it was the case in the non-certified operating mode shown in FIG. 1.

For that purpose, the module MOD₁ interrogates for example the module MOD₄ about the presence in this module of an attribute of compliance, and in the absence of a positive answer, inhibits all its calls to the concerned module MOD₄.

Likewise, when the primary module MOD_{P} calls on the module MOD₂ for the execution of the command CMD₂, the function FN₂ of the module MOD₂ is executed in a manner adapted to the certified mode, herein for example by providing the display of certified icons (i.e. compliant with the standard, herein ECDIS) ICON₂, different from the icons ICON₁ displayed in the non-certified operating mode.

The module MOD₃ having no attribute of compliance, the primary module MOD_{P} does not call on the functions thereof (the function FN₃ implementing the command CMD₃).

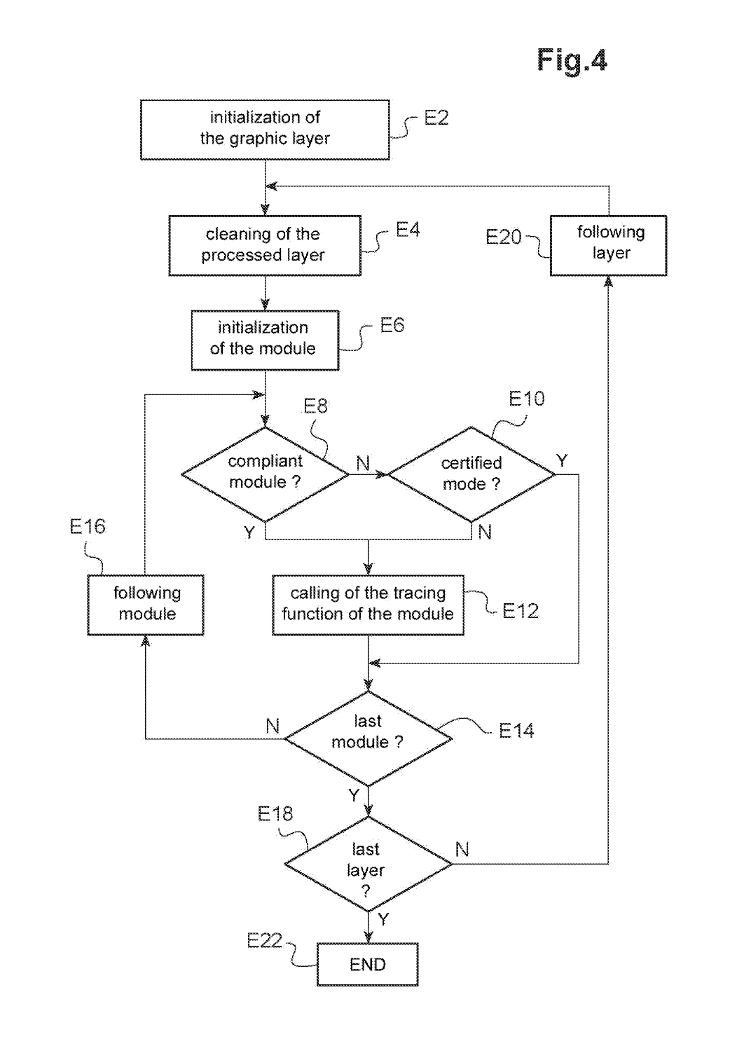

As already mentioned, the primary module MOD_{P} also manages the display, for example in compliance with the method described hereinafter, with reference to FIG. 4.

The primary module MOD_{P} calls on the tracing functions AFF₂, AFF₃ only for the tracing functions relating to compliant modules (herein the module MOD₂), in compliance with what indicates the attribute of compliance of the concerned module, for example in response to a request of the primary module MOD_{P} for that purpose.

The primary module MOD_{P} then calls in particular the tracing function AFF₂ of the module MOD₂, which causes the tracing on the screen ECR of the certified icons ICON₂, generated during the execution of the function FN₂ as indicated hereinabove.

An operation compliant with the ECDIS standard is hence obtained by simple change of value of the indicator IND of the current operating mode, for example upon a command from the user.

The tracing function AFF₃ being on the other hand contained in a module with no attribute of compliance, the primary module MOD_{P} will not call on this tracing function AFF₃ when the indicator IND of the current operating mode is representative of the certified operating mode.

It results from the just-described example that the compliant modules MOD_{P}, MOD₁, MOD₂ are designed to call a function of another module only when the indicator is representative of the non-certified operating mode or when the other module has an attribute of compliance (as moreover also explained hereinafter with reference to FIGS. 4 and 5).

Hence, when the indicator is representative of the certified operating mode, neither the primary module MOD_{P} nor the other compliant modules MOD₁, MOD₂ will call on a module with no attribute of compliance MOD₃, MOD₄. The inhibition of the calls to the modules with no attribute of compliance during the operation in the certified mode hence propagates to the compliant modules: as soon as the execution of the navigational aid method begins in the primary module MOD_{P} (compliant), only calls to compliant modules will be able to be performed in the certified mode, wherein these compliant modules will themselves call only compliant modules in the certified operating mode. It is hence ensured by recursiveness that no module with no attribute of compliance will be able to be called during the operation in the certified mode.

The characteristic provided hereinabove for the compliant modules (call of a function of a module only in the non-certified operating mode or when the module has an attribute of compliance) can be verified during the certification; the modules with no attribute of compliance can on the other hand be designed independently of any certification: due to the proposed design, they will be able to be called in the non-certified operating mode (herein non-ECDIS), but will not be called in the certified operating mode (herein ECDIS) and hence will not risk to disturb the operation of this certified mode.

FIG. 4 shows an example of a method of displaying graphic representations on the screen ECR.

It considered, for example, in the example described, that the display is formed of the superimposition of several graphic layers, each module being able to trace one or several graphic objects (such as the icons) in each graphic layer.

The method of FIG. 4 begins at step E2 by the initialization of the graphic layer, i.e. by the taking into account of a first graphic layer as the current graphic layer.

It is then proceeded, at step E4, to the cleaning of the current graphic layer so that all the graphic elements of this layer can be updated.

It is then proceeded, at step E6, to the initialization of the processed module, i.e. the taking into account of a first module as the current module.

It is then determined at step E8 if the current module is a compliant module, herein according to the ECDIS standard, for example by interrogating the current module about the presence of an attribute of compliance for this module.

If the module is determined as being compliant (for example due to the presence of an attribute of compliance for this module), it is proceeded directly to step E12 described hereinafter.

On the other hand, when the module is not compliant with the operation in the certified mode, i.e. for example when the current module does not reply by a positive answer to a request of presence of an attribute of compliance, it is proceeded to step E10 in which it is verified if the current operating mode, as shown by the indicator IND, is the certified operating mode.

In the negative, it is proceeded to step E12 in which the tracing function of the current module is called.

It is then proceeded to step E14 described hereinafter.

If the operating mode indicator IND is on the contrary representative of the certified operating mode (test of step E10), it is proceeded directly to step E14 without calling on the tracing function (as provided at step E12).

Hence, if is it determined at step E8 that the module was not compliant with an operation in the certified mode and that the certified mode is active, the tracing function of the concerned module is not called on.

It is determined at step E14 whether the current module is the last module to be considered.

In the negative, the following module (step E16) is considered and the operation of the program loops to step E8 for the processing of the following module.

If is determined at step E14 that the current module is the last module to be processed, it is proceeded to step E18.

It is determined at step E18 if the current layer is the last layer to be processed.

In the negative, the following layer is considered (at step E20) and the operation loops to step E4 for the processing of the new current graphic layer.

If it is determined on the contrary at step E18 that the previously processed graphic layer is the last layer to be processed, the display management process ends at step E22.

FIG. 5 shows the main steps of a method of updating an interactive menu, formed of a plurality of tool bars, which each comprise a list of commands, such as those mentioned hereinabove.

The method begins at step E30 in which the processed tool bar is initialized, i.e. in which the first tool bar is considered as the current tool bar.

It is then proceeded to step E32, in which the current command within the current tool bar is initialized, i.e. in which the first command to be processed among the different commands of the current tool bar is considered.

It is then proceeded to step E34 in which it is determined if the module that contains the function implementing the current command is compliant with the operation in certified mode (herein compliant with the ECDIS standard). For that purpose, the main module MOD_{P} transmits for example a request of interrogation about the presence of an attribute of compliance to the module that contains the function implementing the current command.

If it is determined that this module is compliant (i.e. herein if the primary module MOD_{P} receives from this module a confirmation of the presence of an attribute of compliant in this module containing the function associated with the current command), it is directly proceeded to step E38 described hereinafter.

If it is determined on the contrary at step E34 that the module containing the function implementing the current command is not compliant with the certified operation mode, it is proceeded to step E36 in which it is determined if the current operating mode is certified, for example by looking at the indicator IND representative of the current operating mode.

In the negative, it is proceeded to step E38 in which the primary module MOD_{P} transmits a request of state of the command to the module containing the function implementing the current command.

In this case, the command is activated or deactivated as a function of the answer transmitted by the concerned module: it is incumbent over the concerned module to determine whether the user can demand or not the execution of the concerned command in the current mode.

It is observed that, when the concerned module is compliant (positive answer to the test of step E34), the concerned module looks at the indicator IND of the current operating mode and determines, as a function of the current operating mode, whether the concerned command has to be activated or not.

The tool bar is then updated as a function the answer received from the concerned module: for example, the command is presented as being able to be triggered when the concerned module indicates an activated state of the concerned command, and as being inactive (for example, in a grey form) when the concerned module indicates that the command is inactive.

If it is determined at step E36 that the current operating mode is the certified operating mode (by reading of the current operating mode indicator IND), it is proceeded to step E40, in which the current command is deactivated. The tool bar is then updated to indicate that the current command is no longer active, for example by displaying this command in grey and by inhibiting the selection of the associated functionality by the user.

Then, when the module containing the function implementing the current command is not indicated as being compliant (as determined by the absence of attribute of compliance of the concerned module) and that the current operating mode is certified (as determined by the indicator IND), the command is systematically deactivated by the primary module MOD_{P}, which allows to inhibit any execution of a function in a module that would not operate according to the ECDIS standard.

Step E38 as step E40 are followed with step E42, in which it is determined if the current command is the last command to be processed in the current tool bar. In the negative, the following command in the tool bar is considered so as to be processed (step E43) and the process loops for that purpose to the previously-described step E34.

If the command processed hereinabove is the last command to be processed in the current tool bar, step E42 is followed with step E44 in which it is determined if the previously processed tool bas is the last tool bar to be processed.

In the negative, the following tool bar (step E46) is considered so as to be processed, by looping the operation to the already-described step E32.

If the previously processed tool bar is the last tool bar to be processed as determined at step E44, the method of updating the tool bars ends at step E48. The invention is not limited to the just-described embodiment.

In particular, the tool bars are an example of interactive menus that can be used and the icons are an example of conceivable graphic elements to help the user in his navigation (herein maritime). Other types of interactive menus and graphic elements, or graphic representations, are conceivable without departing from the framework of the invention. Likewise, it may be provided to use, in addition to the non-certified operating mode or to the certified operating mode, an alternative certified operating mode, for example an operating mode of the “Maps and mobiles only” type, in which all the graphic objects, navigation tools and other distinct pieces of information from the cartography and the mobiles (herein, boats) are not displayed.

The current operating mode indicator can then take (upon a command from the user through the interface I) a value representative of this alternative certified operating mode. This alternative certified operating mode is then managed as the certified operating mode described hereinabove: the compliant modules are designed to call a function of another module only when the indicator is representative of the non-certified operating mode or when the other module has an attribute of compliance. Hence, during the operation in the certified or alternative certified mode, only compliant modules, designed to look at the indicator IND or to operate, as the case may be, in the alternative certified operating mode, are executed.

Furthermore, in the example described hereinabove, the primary module MOD_{P} is designed to manage the certified mode and the display, as described hereinabove, in particular within the framework of the methods shown in FIGS. 4 and 5.

According to a conceivable variant, in particular when an architecture of the components/container type is used, the management of the certified mode and/or the management of the display could be implemented at the container (sometimes referred to as core or docking structure). It could also be provided according to another variant that the management of the certified mode (ECDIS in the case considered herein) and/or the management of the display are implemented by another compliant module than the primary module MOD_{P}; the primary module could in this case call on this other module for the management of the certified mode and of the display, this other module being then designed to call on the modules MOD₁, MOD₂, MOD₃ in the same conditions than exposed hereinabove regarding the primary module MOD_{P}.

1. A navigational aid system, designed to switch between an operating mode certified according to a standard and a non-certified operating mode,
characterized in that it is based on a modular architecture, in that it is implemented by the execution of modules (MOD₁, MOD₂) compliant with the standard and having an attribute of compliance and of modules (MOD₃, MOD₄) with no attribute of compliance, in that it comprises an indicator (IND) representative of the current operating mode,
and in that the compliant modules (MOD₁, MOD₂, MOD_{P}) are designed to call a function (FN1; FN2; FN3; SRV) of another module (MOD₂; MOD₂; MOD₃; MOD₄) only when the indicator (IND) is representative of the non-certified operating mode or when the other module (MOD₂; MOD₂) has an attribute of compliance.

2. The navigational aid system according to claim 1, wherein at least one compliant module (MOD₂; MOD₂) is designed to look at the indicator (IND) and to adapt its operation as a function of the operating mode indicated by the indicator (IND).

3. The navigational aid system according to claim 1, wherein the system is designed to transmit, to at least one compliant module (MOD₁; MOD₂), a notification specifying that the indicator (IND) has a determined value and wherein the compliant module (MOD₁; MOD₂) is designed to adapt its operation as a function of the operating mode indicated by said determined value.

4. The navigational aid system according to claim 1, wherein at least one compliant module (MOD₁; MOD_{P}) is designed to determine if another module (MOD₁; MOD₂; MOD₃; MOD₄) has an attribute of compliance by interrogating said other module (MOD₁; MOD₂; MOD₃; MOD₄).

5. The navigational aid system according to claim 1, wherein a graphic interface management element (MOD_{P}) is designed to call a function (AFF2; AFF3) of tracing on a screen (ECR) of the system, implemented by a graphic module (MOD₂; MOD₃), only when the indicator (IND) is representative of the non-certified operating mode or when the graphic module (MOD₂) has an attribute of compliance.

6. The navigational aid system according to claim 1, wherein an operating mode management element (MOD_{P}) is designed to interrogate a given module (MOD₁; MOD₂; MOD₃) about the availability of a command (CMD1; CMD2; CMD3) of the given module (MOD₁; MOD₂; MOD₃) when the indicator (IND) is representative of the non-certified operating mode or when the given module (MOD₁; MOD₂) has an attribute of compliance, and to deactivate said command in the other cases.

7. The navigational aid system according to claim 1, wherein the indicator can take a value representative of an alternative certified operating mode and wherein at least one compliant module is designed to adapt its operation to the alternative certified mode when the indicator has the value representative of the alternative certified operating mode.

8. A method implemented in a navigational aid system designed to switch between an operating mode certified according to a standard and a non-certified operating mode,
characterized in that the system is based on a modular architecture, in that the method is implemented by the execution of modules (MOD₁, MOD₂) compliant with the standard, having an attribute of compliance, and of modules (MOD₃, MOD₄) having no attribute of compliance,
and in that the method comprises the following steps:
updating of an indicator (IND) representative of the current operating mode,
calling of a function (FN1; FN2; FN3; SRV) of another module only when the indicator (IND) is representative of the non-certified operating mode or when the other module (MOD₁; MOD₂) has an attribute of compliance.

9. The method of claim 8, comprising the following steps:
look-up of the indicator (IND) by a compliant module (MOD₁; MOD₂);
adaptation, by the compliant module (MOD₁; MOD₂), of the operation thereof as a function of the operating mode indicated by the indicator (IND).

10. The method of claim 8, comprising the following steps:
transmission, to at least one compliant module (MOD₁; MOD₂), of a notification specifying that the indicator (IND) has a determined value;
adaptation, by the compliant module (MOD₁; MOD₂), of the operation thereof as a function of the operating mode indicated by said determined value.

11. The method according to claim 8, comprising a step of interrogation of another module (MOD₁; MOD₂; MOD₃; MOD₄) by a compliant module (MOD₁; MOD_{P}) to determine if the other module (MOD₁; MOD₂; MOD₃; MOD₄) has an attribute of compliance.

12. The method according to claim 8, comprising a step of calling, by a graphic interface management element (MOD_{P}), of a function (AFF2; AFF3) of tracing on a screen (ECR) of the system, implemented by a graphic module (MOD₂; MOD₃), only when the indicator (IND) is representative of the non-certified operating mode or when the graphic module (MOD₂) has an attribute of compliance.

13. The method according to claim 8, comprising a step of interrogation, by an operating mode management element (MOD_{P}), of a given module (MOD₁; MOD₂; MOD₃) about the availability of a command (CMD1; CMD2; CMD3) of the given module (MOD₁; MOD₂; MOD₃) when the indicator (IND) is representative of the non-certified operating mode or when the given module (MOD₁; MOD₂) has an attribute of compliance, or of deactivation of said command in the other cases.

14. The method according to claim 8, wherein the indicator can take a value representative of an alternative certified operating mode and comprising a step of adaptation, by at least one compliant module, of the operation thereof to the alternative certified operating mode when the indicator has the value representative of the alternative certified operating mode.

15. The method according to claim 9, comprising a step of interrogation of another module (MOD₁; MOD₂; MOD₃; MOD₄) by a compliant module (MOD₁; MOD_{P}) to determine if the other module (MOD₁; MOD₂; MOD₃; MOD₄) has an attribute of compliance.

16. The method according to claim 9, comprising a step of calling, by a graphic interface management element (MOD_{P}), of a function (AFF2; AFF3) of tracing on a screen (ECR) of the system, implemented by a graphic module (MOD₂; MOD₃), only when the indicator (IND) is representative of the non-certified operating mode or when the graphic module (MOD₂) has an attribute of compliance.

17. The method according to claim 9, comprising a step of interrogation, by an operating mode management element (MOD_{P}), of a given module (MOD₁; MOD₂; MOD₃) about the availability of a command (CMD1; CMD2; CMD3) of the given module (MOD₁; MOD₂; MOD₃) when the indicator (IND) is representative of the non-certified operating mode or when the given module (MOD₁; MOD₂) has an attribute of compliance, or of deactivation of said command in the other cases.

18. The navigational aid system according to claim 2, wherein at least one compliant module (MOD₁; MOD_{P}) is designed to determine if another module (MOD₁; MOD₂; MOD₃; MOD₄) has an attribute of compliance by interrogating said other module (MOD₁; MOD₂; MOD₃; MOD₄).

19. The navigational aid system according to claim 2, wherein a graphic interface management element (MOD_{P}) is designed to call a function (AFF2; AFF3) of tracing on a screen (ECR) of the system, implemented by a graphic module (MOD₂; MOD₃), only when the indicator (IND) is representative of the non-certified operating mode or when the graphic module (MOD₂) has an attribute of compliance.

20. The navigational aid system according to claim 2, wherein an operating mode management element (MOD_{P}) is designed to interrogate a given module (MOD₁; MOD₂; MOD₃) about the availability of a command (CMD1; CMD2; CMD3) of the given module (MOD₁; MOD₂; MOD₃) when the indicator (IND) is representative of the non-certified operating mode or when the given module (MOD₁; MOD₂) has an attribute of compliance, and to deactivate said command in the other cases.
